(19) United States
(12) Patent Application Publication
(10) Pub. No.: US 2015/0332170 A1
(43) Pub. Date: Nov. 19, 2015

(54) ELECTRONIC SYSTEM WITH LOW CONFIDENCE PREDICTION AND METHOD OF OPERATION THEREOF

(71) Applicant: Samsung Electronics Co., Ltd., Suwon-si (KR)

(72) Inventor: Prabal Sharma, Austin, TX (US)

(21) Appl. No.: 14/543,705

(22) Filed: Nov. 17, 2014

Related U.S. Application Data
(60) Provisional application No. 61/994,286, filed on May 16, 2014.

(51) Int. Cl. G06N 99/00; G06N 5/02

(52) U.S. Cl. CPC G06N 99/005; G06N 5/02

(57) ABSTRACT

An electronic system includes: a base circuit configured to determine a weight for a base prediction; an alternate circuit, coupled to the base circuit, configured to calculate a bit combined with the weight for an alternate prediction; and electronic circuits, coupled to the alternate circuit, configured to select the base prediction or the alternate prediction based on a threshold.

### CROSS-REFERENCE TO RELATED APPLICATION(S)

This application claims the benefit of U.S. Provisional Patent Application Ser. No. 61/994,286 filed May 16, 2014, and the subject matter thereof is incorporated herein by reference thereto.

### TECHNICAL FIELD

An embodiment of the present invention relates generally to an electronic system, and more particularly to a system for prediction.

### BACKGROUND

Modern consumer and industrial electronics, especially devices such as graphical display systems, televisions, projectors, cellular phones, portable digital assistants, and combination devices, are providing increasing levels of functionality to support modern life including three-dimensional display services. Research and development in the existing technologies can take a myriad of different directions.

Performance improvements in electronic devices can include predictive algorithms. Predicting behavior, particularly with instructions for an electronic device, can significantly improve performance such as throughput of an electronic device. Confidence in predicting behavior can significantly affect performance as incorrect predictions can be very costly.

Predicting behavior benefits from training New behaviors with minimal training will have low confidence predictions. Alternatively, over-training can be detrimental with increases in power consumption. Both too little training and too much training can significantly reduce the benefits of predicting behavior.

Thus, a need still remains for an electronic system with a prediction mechanism for low confidence prediction. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a base circuit configured to determine a weight for a base prediction; an alternate circuit, coupled to the base circuit, configured to calculate a bit combined with the weight for an alternate prediction; and electronic circuits, coupled to the alternate circuit, configured to select the base prediction or the alternate prediction based on a threshold.

An embodiment of the present invention provides a method of operation of an electronic system including: determining a weight for a base prediction; calculating a bit combined with the weight for an alternate prediction; and selecting the base prediction or the alternate prediction based on a threshold.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an electronic system in an embodiment of the invention.

FIG. 2 is a control flow of the electronic system in an embodiment of the invention.

FIG. 3 is a control flow with additional detail of the electronic system in an embodiment of the invention.

FIG. 4 is exemplary embodiments of the electronic system in use.

FIG. 5 is a flow chart of a method of operation of an electronic system in an embodiment of the present invention.

### DETAILED DESCRIPTION

An embodiment of the invention targets low confidence predictions made by the perceptron branch predictor. Predictions classified as being low confidence can use an alternate process that factors usefulness of individual components such as weights, biases, or combination thereof, in making correct predictions.

A branch predictor can provide a prediction, such as a likely branch, a probable branch, a branch with a high probability of accuracy, or combination thereof, selected from multiple branches based on training with previous outputs, branches, paths, instructions, or combination thereof. The branch predictor can utilize a pipeline to increase throughput such as an instruction pipeline to increase instruction throughput. For example, a microprocessor with a branch predictor can process instructions in parallel instead of sequentially. Perceptron branch predictors use dynamic thresholds (theta) for adaptively switching the training process on or off. This is done so as to not over-train weight tables, save power, and to ensure that new branches take the optimum time to train prediction states.

However, the perceptron output, such as sum of weights and biases, can be unstable for branches when they are newly discovered. In the process of being trained on these new branches, the perceptron usually enters a low of confidence region when the sum value is close to zero. In this region of low confidence, the predictor is highly susceptible to making incorrect predictions, owing to recovery from the state previously trained by older or stronger aliasing branches.

An embodiment of the invention makes it possible to morph the presently existing state, while computing the sum, in a way that more accurately represents branch behavior even as the predictor continues to be trained. Embodiments of the invention can include more than one predictor process.

The following embodiments are described in sufficient detail to enable those skilled in the art to make and use the invention. It is to be understood that other embodiments would be evident based on the present disclosure, and that system, process, or mechanical changes may be made to embodiments without departing from the scope of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

The term “process” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

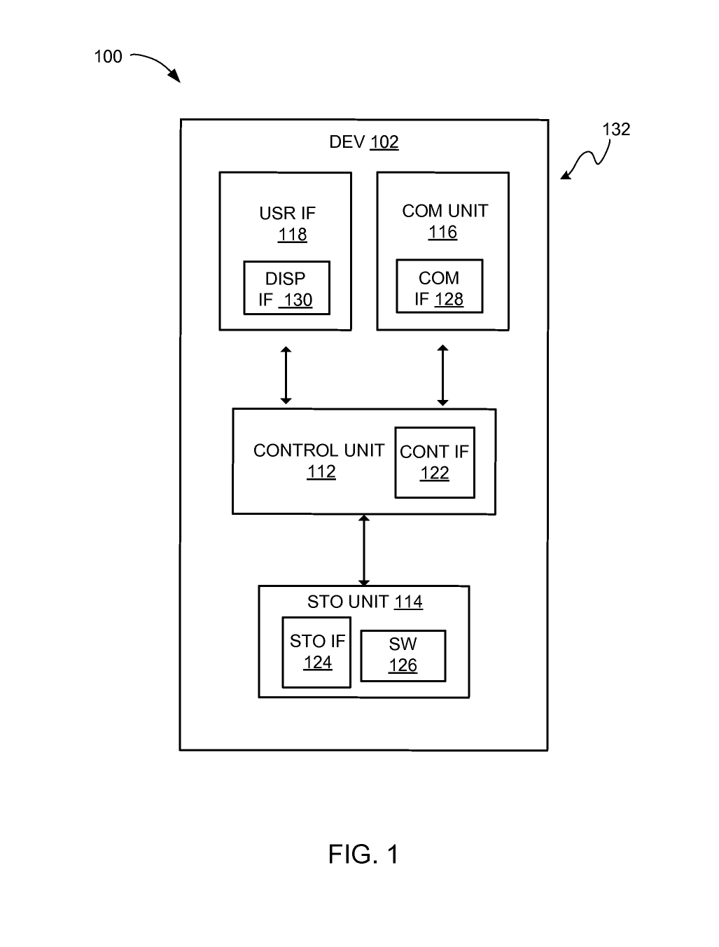

Referring now to FIG. 1, therein is shown an exemplary block diagram of the electronic system 100 in an embodiment of the invention. The electronic system 100 can include a device 102. The device 102 can include a client device, a server, a display interface, or combination thereof.

The device 102 can include a control unit 112, a storage unit 114, a communication unit 116, and a user interface 118. The control unit 112 can include a control interface 122. The control unit 112 can execute a software 126 of the electronic system 100.

The control unit 112 can be implemented in a number of different manners. For example, the control unit 112 can be a processor, an application specific integrated circuit (ASIC) an embedded processor, a microprocessor, a hardware control logic, a hardware finite state machine (FSM), a digital signal processor (DSP), or a combination thereof. The control interface 122 can be used for communication between the control unit 112 and other functional units in the device 102. The control interface 122 can also be used for communication that is external to the device 102.

The control interface 122 can receive information from the other functional units or from external sources, or can transmit information to the other functional units or to external destinations. The external sources and the external destinations refer to sources and destinations external to the device 102.

The control interface 122 can be implemented in different ways and can include different implementations depending on which functional units or external units are being interfaced with the control interface 122. For example, the control interface 122 can be implemented with a pressure sensor, an inertial sensor, a microelectromechanical system (MEMS), optical circuitry, waveguides, wireless circuitry, wireline circuitry, or a combination thereof.

The storage unit 114 can store the software 126. The storage unit 114 can also store relevant information, such as data, images, programs, media, or a combination thereof. The storage unit 114 can be sized to provide additional storage capacity.

The storage unit 114 can be a volatile memory, a nonvolatile memory, an internal memory, an external memory, or a combination thereof. For example, the storage unit 114 can be a nonvolatile storage such as non-volatile random access memory (NVRAM), Flash memory, disk storage, or a volatile storage such as static random access memory (SRAM), dynamic random access memory (DRAM), any memory technology, or combination thereof.

The storage unit 114 can include a storage interface 124. The storage interface 124 can be used for communication with and other functional units in the device 102. The storage interface 124 can also be used for communication that is external to the device 102.

The storage interface 124 can receive information from the other functional units or from external sources, or can transmit information to the other functional units or to external destinations. The external sources and the external destinations refer to sources and destinations external to the device 102.

The storage interface 124 can include different implementations depending on which functional units or external units are being interfaced with the storage unit 114. The storage interface 124 can be implemented with technologies and techniques similar to the implementation of the control interface 122.

For illustrative purposes, the storage unit 114 is shown as a single element, although it is understood that the storage unit 114 can be a distribution of storage elements. Also for illustrative purposes, the electronic system 100 is shown with the storage unit 114 as a single hierarchy storage system, although it is understood that the electronic system 100 can have the storage unit 114 in a different configuration. For example, the storage unit 114 can be formed with different storage technologies forming a memory hierarchal system including different levels of caching, main memory, rotating media, or off-line storage.

The communication unit 116 can enable external communication to and from the device 102. For example, the communication unit 116 can permit the device 102 to communicate with a second device (not shown), an attachment, such as a peripheral device, a communication path (not shown), or combination thereof.

The communication unit 116 can also function as a communication hub allowing the device 102 to function as part of the communication path and not limited to be an end point or terminal unit to the communication path. The communication unit 116 can include active and passive components, such as microelectronics or an antenna, for interaction with the communication path.

The communication unit 116 can include a communication interface 128. The communication interface 128 can be used for communication between the communication unit 116 and other functional units in the device 102. The communication interface 128 can receive information from the other functional units or can transmit information to the other functional units.

The communication interface 128 can include different implementations depending on which functional units are being interfaced with the communication unit 116. The communication interface 128 can be implemented with technologies and techniques similar to the implementation of the control interface 122, the storage interface 124, or combination thereof.

The user interface 118 allows a user (not shown) to interface and interact with the device 102. The user interface 118 can include an input device, an output device, or combination thereof. Examples of the input device of the user interface 118 can include a keypad, a touchpad, soft-keys, a keyboard, a microphone, an infrared sensor for receiving remote signals, other input devices, or any combination thereof to provide data and communication inputs.

The user interface 118 can include a display interface 130. The display interface 130 can include a display, a projector, a video screen, a speaker, or any combination thereof.

The control unit 112 can operate the user interface 118 to display information generated by the electronic system 100. The control unit 112 can also execute the software 126 for the other functions of the electronic system 100. The control unit 112 can further execute the software 126 for interaction with the communication path via the communication unit 116.

The device 102 can also be optimized for implementing an embodiment of the present invention in a multiple device embodiment. The device 102 can provide additional or higher performance processing power.

The electronic system 100 can be implemented by the control unit 112. For illustrative purposes, the device 102 is shown partitioned with the user interface 118, the storage unit 114, the control unit 112, and the communication unit 116, although it is understood that the device 102 can have any different partitioning. For example, the software 126 can be partitioned differently such that at least some function can be in the control unit 112 and the communication unit 116. Also, the device 102 can include other functional units not shown in for clarity.

The functional units in the device 102 can work individually and independently of the other functional units. For illustrative purposes, the electronic system 100 is described by operation of the device 102 although it is understood that the device 102 can operate any of the processes and functions of the electronic system 100 such as a training process, prediction process, compare process, confidence process, modified processes of the aforegoing, or combination thereof. The training process can be based on history of selections. The prediction process can use this history for predictions. The confidence process can determine a level of training based on this history. The compare process can determine which of the prediction or modified prediction is appropriate based on a confidence determined by the confidence process.

Processes described further below in this application can be implemented in hardware such as hardware circuitry, or hardware accelerators in the control unit 112. The processes can also be implemented within the device 102 but outside the control unit 112.

Processes in this application can be part of the software 126. These processes can be implemented in software and stored in the storage unit 114. The control unit 112 can execute these processes for operating the electronic system 100.

The device 102, the control unit 112, the storage unit 114, the communication unit 116, the user interface 118, or combination thereof, can be implemented in electronic circuits 132 such as digital logic gates, analog circuitry, or combination thereof. The functions of the device 102, the control unit 112, the storage unit 114, the communication unit 116, the user interface 118, or combination thereof, can be implemented without the need for analog circuits.

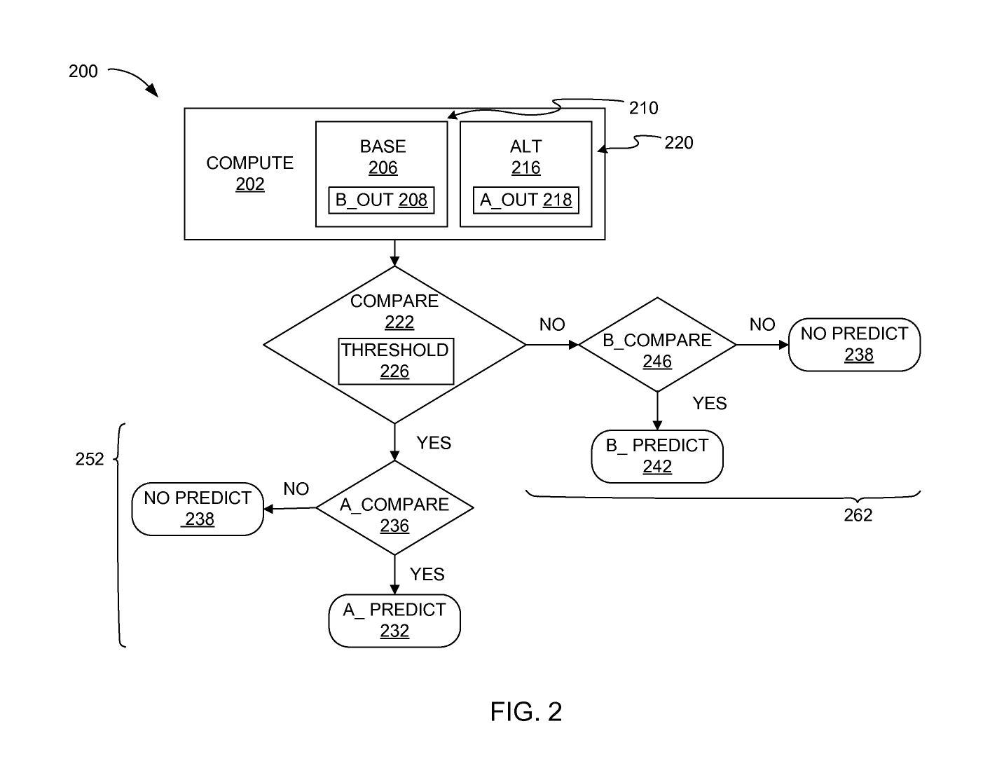

Referring now to FIG. 2, therein is shown a control flow of the electronic system 100 in an embodiment of the invention. A predictor process 200, such as a branch predictor process 200, can be implemented in electronic circuits 132 such as digital logic gates 132, analog circuitry, or combination thereof. For example, the predictor process 200 can be implemented in the control unit 112. In an embodiment improved predictions for a region of low confidence can include an alternative prediction instead of a primary prediction. In another embodiment improved prediction can include an alternative prediction in the region of low confidence, and a primary prediction in a region previously trained. In a further embodiment, a trained prediction and a modified prediction can be computed simultaneously before determining which prediction is to be used.

The predictor process 200 can provide a prediction, such as a likely branch, a probable branch, a branch with a high probability of accuracy, or combination thereof, selected from multiple branches based on training with previous outputs, branches, paths, instructions, or combination thereof. The predictor process 200 can utilize a pipeline to increase throughput such as an instruction pipeline to increase instruction throughput. For example, a microprocessor such as the control unit 112 with the predictor process 200 can process instructions in parallel instead of sequentially.

The predictor process 200 can include two potential outputs such as outputs computed by a perceptron or a neural perceptron with a compute process 202. A base process 206 can provide a base output 208 such as a base confidence level 208, and an alternate process 216 such as a modified process can provide an alternate output 218 such as an alternate confidence level. The base output 208, the alternate output 218, or combination thereof, can predict the likely branch, the probable branch, the branch with a high probability of accuracy, or combination thereof.

The base process 206 can include a base circuit 210 such as base digital logic gates, analog circuitry, or combination thereof, executing a base algorithm to provide the base output 208. The base process 206 can be implemented in electronic circuits such as digital logic gates, analog circuitry, or combination thereof. For example, the base process 206 can be implemented in the control unit 112. Similarly, the alternate process 216 can include an alternate circuit 220 such as alternate digital logic gates, analog circuitry, or combination thereof, executing an alternate algorithm to provide the alternate output 218. The alternate process 216 can be implemented in the electronic circuit 220. For example, the alternate process 216 can be implemented in the control unit 112.

The predictor process 200 can also include a compare process 222 with a threshold 226 such as a dynamic threshold, “theta/x”, or combination thereof. The threshold 226 can determine whether the base prediction 242, the alternate prediction 232, or combination thereof, is used. For example, the base prediction 242 can be used with the threshold 226 greater than the base output 208. Similarly, the alternate prediction 232 can be used with the threshold 226 less than the base output 208.

In an embodiment, the predictor process 200 can compute the base prediction 242 or the alternate prediction 232 simultaneously. The predictor process 200 can determine which of the base prediction 242 or the alternate prediction 232 is to be used. Determining which of the base prediction 242 or the alternate prediction 232 is to be used includes comparing the threshold 226 with the base output 208 such as the base confidence level, the alternate output 218 such as the alternate confidence level, or combination thereof.

In another embodiment, the predictor process 200 can compute the base prediction 242 or the alternate prediction 232 continuously. The predictor process 200 can determine which of the base prediction 242 or the alternate prediction 232 is to be used without the need for switching training on or off since both the base prediction 242 and the alternate prediction 232 can be available substantially simultaneously.

In yet another embodiment, the predictor process 200 can compute the base prediction 242 before or prior to the alternate prediction 232. The predictor process 200 can determine which of the base prediction 242 or the alternate prediction 232 is to be used based on the base output 208. The predictor process 200 can determine whether the alternate prediction 232 needs to be computed.

In yet another embodiment, the predictor process 200 can compute the base prediction 242 or the alternate prediction 232 based on predetermining which of the base prediction 242 or the alternate prediction 232 is to be used. Determining which of the base prediction 242 or the alternate prediction 232 can be used includes comparing the threshold 226 with the base output 208 such as the base confidence level, the alternate output 218 such as the alternate confidence level, or combination thereof.

For example, an alternate compare process 236 can select the alternate prediction 232 with an absolute value of the base output 208 less than the threshold 226 and the alternate confidence level 218 greater than zero (0). The alternate compare process 236 can select an alternate prediction not taken process 238 with the alternate confidence level 218 less than zero (0). Alternatively, the base compare process 246 can select the base prediction 242 with an absolute value of the base confidence level 208 greater than the threshold 226 and greater than zero (0). The base compare process 246 can select a base prediction not taken process 248 with the base confidence level 208 less than zero (0).

The base output 208, the alternate output 218, or combination thereof, provide improved prediction reducing incorrect predictions particularly in a low confidence region of predictions determined by low confidence region processes 252, a low confidence state, a low confidence process, or combination thereof. For example, the low confidence region 252 can be identified by a sum, quantity, or number of predictions close to zero (0). For example, incorrect predictions in the low confidence region 252 can result at least in part due to recovery from states, regions, or processes trained with older or stronger branches.

In at least some embodiments, the predictor process 200 can switch a training process on or off to optimize training of tables such as to avoid over training tables particularly in a trained region of predictions determined by trained region processes 262. The training process can switch on or off training with one or more of the previous outputs, the branches, the paths, the instructions, or combination thereof. The training process can require a period of time to train and predict with confidence, the outputs, the branches, the paths, the instructions, or combination thereof.

The base prediction 242, the alternate prediction 232, or combination thereof, can be unstable, such as with a number of incorrect predictions of the outputs, the branches, the paths, the instructions, or combination thereof, during the training process. For example, the training process can include the base output 208 less than the threshold 226 indicating the low confidence region. The base prediction 242, the alternate prediction 232, or combination thereof, are often incorrectly predicted in the low confidence region during the training process.

It has been discovered that the electronic system 100 provides improved predictions for low confidence regions 252. The alternate prediction 232 can be used instead of the base prediction 242 particularly in the low confidence regions 252 for significantly improved predictions.

It has further been discovered that the electronic system 100 can provide improved prediction with the alternate prediction 232 and the base prediction 242. The alternate prediction 232 can be used in the low confidence regions 252 and the base prediction 242 can be used in the trained region 262 for significantly improved predictions.

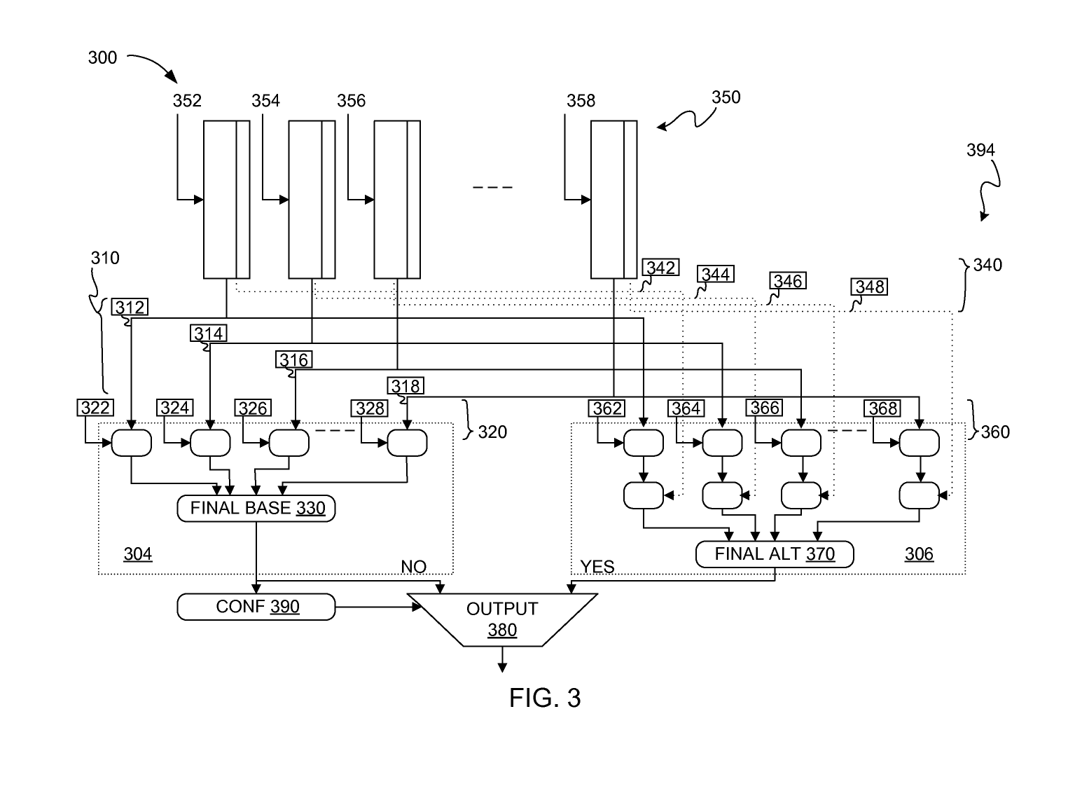

Referring now to FIG. 3, therein is shown a control flow 300 with additional detail of the electronic system 100 in an embodiment of the invention. The control flow 300 can include a base process 304 such as the base process 206 of FIG. 2 with a base algorithm to provide the base output 208 of FIG. 2, and an alternate process 306 such as the alternate process 216 of FIG. 2 with an alternate algorithm to provide the alternate output 218 of FIG. 2.

The control flow 300 including alternate process 306 as well as the base process 304 can be implemented in the electronic circuit 132 of FIG. 1 including the base circuit 210 of FIG. 2, the alternate electronic circuit 220 of FIG. 2, or combination thereof. For example, the alternate process 306, the base process 304, or combination thereof, can be implemented in the control unit 112 of FIG. 1.

Predictions such as the alternate prediction 232 of FIG. 2, the base prediction 242 of FIG. 2, or combinations thereof, can be provided by training based on history such as an index for determining weights and biases. The weights and biases can provide prediction including branch predictions such as a likely branch, a probable branch, a branch with a high probability of accuracy, or combination thereof. The history can include an index of previous outputs, outcomes, branches, paths, instructions, or combination thereof.

Weights 310 such as signed weights can be associated with base coefficients 320, such as a bias, a base static coefficient, or combination thereof. The weights 310 can be described by “sa_x” where “x” can be a sequential integer. The base coefficients 320 can be identified with “sa_0” 322, “sa_1” 324, “sa_2” 326, or “sa_n” 328, where “n” can represent a last sequential integer in a set. The base coefficients 320 can be identified with “weight[0]” 312, “weight[1]” 314, “weight[2]” 316, and “weight[n]” 318 where “n” can represent a last sequential integer in a set.

A sum of each of the base coefficients 320 and each of an associated of the weights 310 determines a final base output 330 such as the base output 208 of FIG. 2. For example, the “weight[0]” 312 can be summed, scaled, multiplied, or combination thereof, with the “sa_0” 302 for providing a prediction. For illustrative purposes, four (4) of the weights 310 and four (4) of the base coefficients 320 are shown although it is understood that any number of the weights 310 or the base coefficients 320 may be used.

The alternate process 306 can include bits 340, such as a single bit, a useful bit, or combination thereof, identified with “bit[0]” 342, “bit[1]” 344, “bit[2]” 346, and “bit[n]” 348, where “n” can represent a last sequential integer in a set. The bits 340 can be added to each of the weights 310 in tables 350 indexed by histories including “history[0]” 352, “history[1]” 354, “history[2]” 356, “history[n]” 358, or combination thereof. The weights 310 can be determined with at least the storage unit 114 of FIG. 1, the control unit 112 of FIG. 1, the communication unit 116 of FIG. 1, the user interface 118 of FIG. 1, or combination thereof.

The bits 340 can indicate whether a particular of the weights 310, such as a single weight, in isolation would have made a same prediction as a correct outcome for a branch such as a branch at a retire time. A bit 340 is updated at the retire time since it is based on an actual outcome of the branch, such as a retire time outcome.

Weights 310 such as signed weights can be associated with alternate coefficients 360, such as a bias, an alternate static coefficient, or combination thereof. The alternate coefficients 360 can be identified with “sb_0” 362, “sb_1” 364, “sb_2” 366, or “sb_n” 368, where “n” can represent a last sequential integer in a set. The alternate coefficients 360 can be identified with “weight[0]” 312, “weight[1]” 314, “weight[2]” 316, and “weight[n]” 318 where “n” can represent a last sequential integer in a set.

The alternate coefficients 360 such as alternate scaling coefficients, multiplicative coefficient, or combination thereof, can be provided for individual weights of the weights 310 and can differ from the base coefficients 320 at least because the alternate coefficients 360 can be determined empirically. The alternate coefficients 360 can be updated or determined at retire time based on an actual outcome, such as a retire time outcome, of the branch in a manner similar to the bit 340.

A sum of each of the alternate coefficients 360 and each of the associated weights 310 determines a final alternate output 370 such as the alternate output 218 of FIG. 2. For example, the “weight[0]” 312 can be summed with the “sb_0” 362 for providing a prediction. For illustrative purposes, four (4) of the weights 310 and four (4) of the alternate coefficients 360 are shown although it is understood that any number of the weights 310 or the alternate coefficients 360 may be used.

The final alternate output 370 can be provided as a final output 380 based on the final base output 330 below a threshold such as the threshold 226 of FIG. 2. The final base output 330 below a threshold can indicate low confidence based on a confidence process 390. The final output 380, such as the base output 208 or the alternate output 218, can be determined by the confidence process 390 in a manner similar to the compare process 222 of FIG. 2. The retire time outcome can include the final base output 330, the final alternate output 370, the final output 380, or combination thereof.

A sign of the weights 310 can be inverted based on the bits 340 such as useful bits. For example, the “bit[0]” 342 with a value of one (1) can indicate that the “weight[0]” 312 was useful in predicting an outcome, such as the final alternate output 370, the alternate output 218, or combination thereof. The bit 340, with the value of 1, can determine a sign of the weight 310 stays the same. Further for example, the “bit[0]” 342 with a value of zero (0) can indicate that the “weight[0]” 312 was not useful in predicting an outcome, such as the final alternate output 370, the alternate output 218, or combination thereof. The “bit[0]” 342, with the value of 0, can determine a sign of the “weight[0]” 312 is inverted or not used.

The bits 340 can result in inverting a contribution of individual of the weights 310, the base coefficients 320, the alternate coefficients 360, or combination thereof, particularly for the low confidence region 252 of FIG. 2. The alternate process 306 such as the alternate process 216 can be implemented with digital circuits or the electronic circuit 132, and scale or invert the weights 310 without the need for analog circuits. For example, the final base output 330 can include a sum of “weight[i] multiplied with “sa_i”, and the final alternate output 370 can include the sum of “weight[i] multiplied with “sa_i” with a multiplier, such as one or negative one, based on a value of the bit 340 such as the useful bit. Further for example, an algorithm can provide the following:

yout=sum(weight[i]*sa_{—}i);

alt_yout=sum((weight[i]*sa_{—}i)*(useful[i]?1:−1));
. . . given, i={0, 1 . . . , n}; weights include bias weight as well

A sign inversion can fix inaccuracies of the weights 310 for a new branch that has started training For example, dynamic weight components 394 such as the bits 340, the alternate coefficients 360, other dynamic components, or combination thereof, can have previously been trained is an opposite direction of the dynamic weight components 394 needed for a prediction such as the alternate prediction 232, the base prediction 242, or combination thereof, of the current or the new branch. The sign inversion prevents the inaccurate weights of the weights 310 that are transitioning toward proper values, from inaccurately contributing to a current prediction such as a likely branch, a probable branch, a branch with a high probability of accuracy, or combination thereof.

It has been discovered that the electronic system 100 with the alternate process 216 applies to perceptron predictors including primitive forms of perceptron predictors that do not use scaled or multiplicative coefficients. The electronic system 100 with the alternate process 216 can correct low confidence predictions for predictor designs of this type as well.

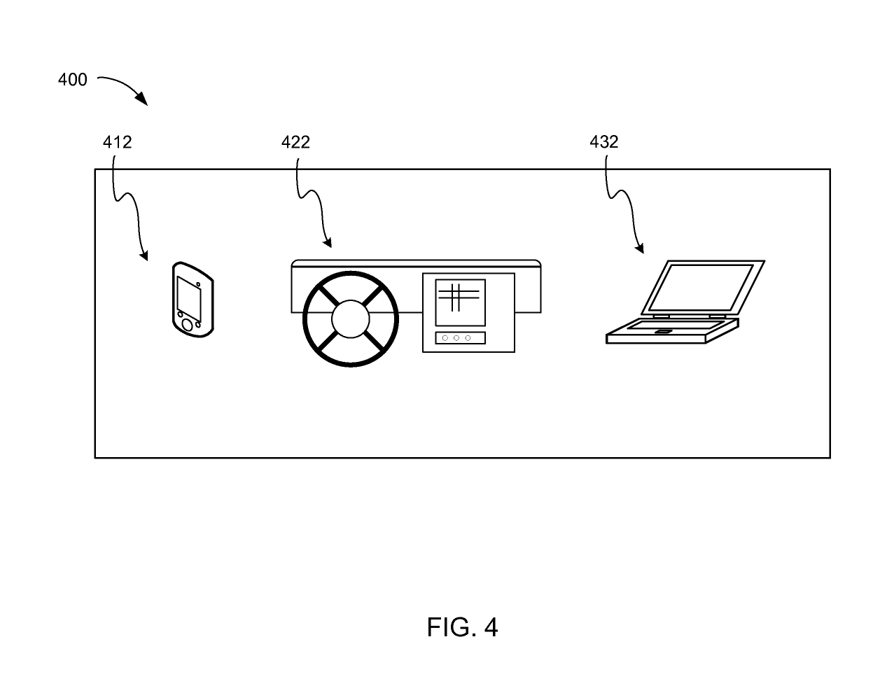

Referring now to FIG. 4, therein is shown exemplary embodiments of the electronic system 100 in use. The exemplary embodiments include application examples for the electronic system 100, such as a smart phone 412, a dash board of an automobile 422, a notebook computer 432, or combination thereof.

These application examples illustrate purposes or functions of various embodiments of the invention and importance of improvements in processing performance including improved prediction, particularly with low confidence. For example, the alternate process 216 of FIG. 2 can provide improved prediction of the alternate output 218 of FIG. 2 significantly improving throughput of the device 102 of FIG. 1 particularly with instructions required for the control unit 112 of FIG. 1.

In an example where an embodiment of the invention is an integrated circuit processor and the alternate process 216 is integrated in the processor, providing data output for a display of the devices can be significantly faster than other devices without the alternate process 216.

The electronic system 100, such as the smart phone 412, the dash board of the automobile 422, and the notebook computer 432, can include a one or more of a subsystem (not shown), such as a printed circuit board having various embodiments of the invention, or an electronic assembly (not shown) having various embodiments of the invention. The electronic system 100 can also be implemented as an adapter card in a smart phone 412, the dash board of an automobile 422, and a notebook computer 432.

Thus, the smart phone 412, the dash board of the automobile 422, the notebook computer 432, other electronic devices, or combination thereof, can provide significantly faster throughput with the electronic system 100 such as processing, output, transmission, storage, communication, display, other electronic functions, or combination thereof. For illustrative purposes, the smart phone 412, the dash board of the automobile 422, the notebook computer 432, other electronic devices, or combination thereof, are shown although it is understood that the electronic system 100 can be used in any electronic device.

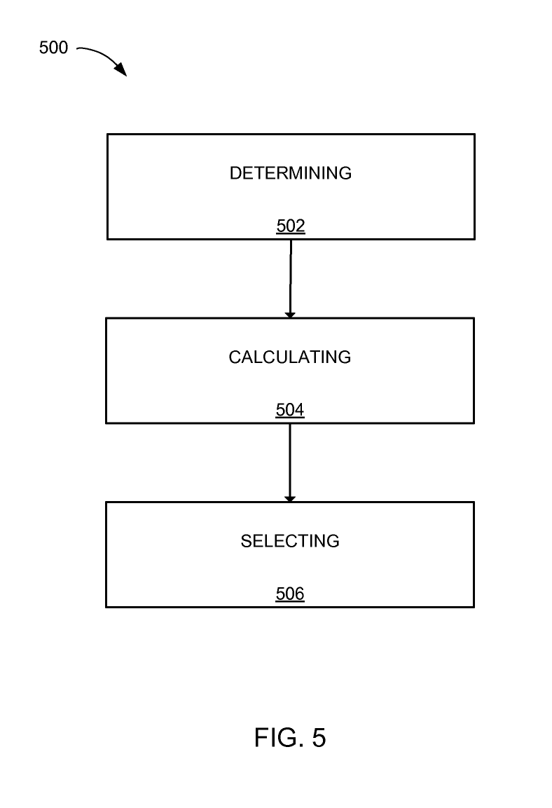

Referring now to FIG. 5, therein is shown a flow chart of a method 600 of operation of an electronic system 100 in an embodiment of the present invention. The method 600 includes: determining a weight for a base prediction in a block 502; calculating a bit combined with the weight for an alternate prediction in a block 604; and selecting the base prediction or the alternate prediction based on a threshold in a block 606.

All of the processes herein can be implemented as hardware, hardware circuitry, or hardware accelerators with the control unit 112 of FIG. 1. The processes can also be implemented as hardware, hardware circuitry, or hardware accelerators with the device 102 of FIG. 1 and outside of the control unit 112.

The electronic system 100 has been described with process functions or order as an example. The electronic system 100 can partition the processes differently or order the processes differently. For example, the base process 206 of FIG. 2 can provide the base output 208 of FIG. 2 for comparison to the threshold 226 of FIG. 2 before the alternate process 216 of FIG. 2 provides the alternate output 218 of FIG. 2. Alternatively, the alternate process 216 can provides the alternate output 218 before the base process 206 can provide the base output 208.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. An electronic system comprising:
a base circuit configured to determine a weight for a base prediction;
an alternate circuit, coupled to the base circuit, configured to calculate a bit combined with the weight for an alternate prediction; and
electronic circuits, coupled to the alternate circuit, configured to select the base prediction or the alternate prediction based on a threshold.

2. The system as claimed in claim 1 wherein the alternate circuit configured to calculate the bit is based on a retire outcome.

3. The system as claimed in claim 1 wherein the base circuit configured to determine the weight is based on a history of outcomes.

4. The system as claimed in claim 1 wherein base circuit configured to determine the weight includes combining a base coefficient with the weight.

5. The system as claimed in claim 1 wherein the alternate circuit configured to calculate the bit includes combining the bit with the weight and an alternate coefficient.

6. The system as claimed in claim 1 wherein the electronic circuits configured to select the base prediction or the alternate prediction includes comparing a base coefficient combined with the weight to the threshold.

7. The system as claimed in claim 1 wherein the electronic circuits configured to select the base prediction or the alternate prediction includes determining the base prediction before the alternate prediction.

8. The system as claimed in claim 1 wherein the electronic circuits configured to select the base prediction or the alternate prediction includes predetermining which of the base prediction or the alternate prediction is to be used.

9. The system as claimed in claim 1 wherein the electronic circuits configured to select the base prediction or the alternate prediction includes calculating the base prediction and the alternate prediction simultaneously.

10. The system as claimed in claim 1 wherein the electronic circuits configured to select the base prediction or the alternate prediction includes calculating the base prediction and the alternate prediction continuously.

11. A method of operation of an electronic system comprising:
determining a weight for a base prediction;
calculating a bit combined with the weight for an alternate prediction; and
selecting the base prediction or the alternate prediction based on a threshold.

12. The method as claimed in claim 11 wherein calculating the bit is based on a retire time outcome.

13. The method as claimed in claim 11 wherein determining the weight is based on a history of outcomes.

14. The method as claimed in claim 11 wherein determining the weight includes combining a base coefficient with the weight.

15. The method as claimed in claim 11 wherein calculating the bit includes combining the bit with the weight and an alternate coefficient.

16. The method as claimed in claim 11 wherein selecting the base prediction or the alternate prediction includes comparing a base coefficient combined with the weight to the threshold.

17. The method as claimed in claim 11 wherein selecting the base prediction or the alternate prediction includes determining the base prediction before the alternate prediction.

18. The method as claimed in claim 11 wherein selecting the base prediction or the alternate prediction includes predetermining which of the base prediction or the alternate prediction is to be used.

19. The method as claimed in claim 11 wherein selecting the base prediction or the alternate prediction includes calculating the base prediction and the alternate prediction simultaneously.

20. The method as claimed in claim 11 wherein selecting the base prediction or the alternate prediction includes calculating the base prediction and the alternate prediction continuously.
